(19) United States
(12) Patent Application Publication
(10) Pub. No.: US 2025/0244055 A1
(43) Pub. Date: Jul. 31, 2025

(54) MAGNETOCALORIC REFRIGERATION FOR SEMICONDUCTOR APPLICATIONS

(71) Applicant: Applied Materials, Inc., Santa Clara, CA (US)

(72) Inventors: Kadali ARUN, Bengaluru (IN); Hari K. PONNEKANTI, San Jose, CA (US); Rony David MATHEW, Bengaluru (IN); Varun Kumar CHENNA, Bengaluru (IN); Somil KAPADIA, Mumbai (IN)

(21) Appl. No.: 19/036,169

(22) Filed: Jan. 24, 2025

(30) Foreign Application Priority Data
Jan. 26, 2024 (IN) 202441005406

(51) Int. Cl. F25B 21/00; B23Q 3/15; H02N 13/00

(52) U.S. Cl. CPC F25B 21/00; B23Q 3/15; H02N 13/00; F25B 2321/002

(57) ABSTRACT

A processing system having a substrate support assembly is described herein. The substrate support includes an electrostatic chuck, a cooling base coupled to the electrostatic chuck, a facility plate coupled to the substrate support assembly, and one or more electrical connectors positioned in the substrate support assembly in electrical communication with the electrostatic chuck. The electrostatic chuck further includes one or more cooling channels fluidly coupled to a magnetocaloric chiller utilizing magnetocaloric refrigeration.

### BACKGROUND

### Field

Embodiments of the present disclosure generally relate to semiconductor chamber components and more particularly to a chiller for a cooled substrate support assembly and a vacuum chamber.

### Description of the Related Art

Reliably producing nanometer and smaller features is one of the key technology challenges for next generation very large scale integration (VLSI) and ultra-large-scale integration (ULSI) of semiconductor devices. However, as the limits of circuit technology are pushed, the shrinking dimensions of VLSI and ULSI interconnect technology have placed additional demands on processing capabilities. Reliable formation of gate structures on the substrate is important to VLSI and ULSI success and to the continued effort to increase circuit density and quality of individual substrates and die.

To drive down manufacturing cost, integrated chip (IC) manufacturers demand higher throughput and better device yield and performance from every silicon substrate processed. Some fabrication techniques being explored for next generation devices under current development require processing at cryogenic temperatures. Dry reactive ion etching a substrate uniformly maintained at a cryogenic temperature enables ions to bombard the upward facing surfaces of materials disposed on the substrate with decreased spontaneous etching so that trenches with smooth, vertical sidewalls are formed. Additionally, selectivity of etching one material versus another can be improved at the cryogenic temperature. For example, selectivity between silicon and other materials.

Operating a substrate support assembly at low temperatures presents many challenges. For example, common refrigerants, such as polyfluoroalkyl substances (PFAS), are subjected to PFAS regulations. Strict PFAS regulations require repetitive qualifications of chiller units to meet the regulations. New regulations have led to an increased cost of the chiller units and increased the energy consumption when operating the chiller units. These challenges increase the cost of production and can lead to many other problems.

Thus, there is a need for an improved refrigeration technology for substrate support assemblies.

### SUMMARY

In one embodiment, a processing system is described having a body. The body has a bottom, a lid and sidewalls. The bottom lid and sidewalls enclose a processing volume. A substrate support assembly is disposed in the processing volume. The substrate support assembly includes an electrostatic chuck, a cooling base coupled to the electrostatic chuck, a facility plate coupled to the substrate support assembly, and one or more electrical connectors positioned in the substrate support assembly in electrical communication with the electrostatic chuck. A magnetocaloric chiller is fluidly coupled to one or more cooling channels in the electrostatic chuck.

In another embodiment, a processing system is provided that includes a vacuum chamber, a cryopump, and a cryopump low temperature stage. The cryopump is coupled to an exhaust of the vacuum chamber. The cryopump low temperature stage is operable to use magnetocaloric refrigeration to cool the cryopump.

In another embodiment, a method for monitoring a processing system is provided. The method includes sensing a metric indicative of one or more process characteristic selected from the group consisting of pressure, flow, temperature, fluid resistivity, valve condition, motor diagnostics and/or other metrics of a chiller and/or processing system; and providing an electronic warning and/or automatically shutting down and/or modifying an operation of the processing system and/or chiller based on the sensed metrics.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a cross-sectional schematic view of an exemplary vacuum processing chamber according to an embodiment.

FIG. 2 is a representative illustration of the operation of a magnetocaloric refrigeration unit.

FIG. 3 is a cross-sectional schematic view of a chiller utilizing having a magnetocaloric refrigeration unit for cooling electrostatic chucks.

FIG. 4 is a cross-sectional schematic view of a cryopump system utilizing magnetocaloric refrigeration unit for vacuum chambers.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments described herein provide a cryopump system that enables a low temperature operation of an electrostatic chuck (ESC) so that a substrate disposed thereon is maintained at a low processing temperature suitable for processing while other surfaces of a processing chamber are maintained at a different temperature. The low processing temperature (i.e., temperature of the substrate) is intended to refer to temperatures less than ambient, i.e., 20 degrees Celsius at the substrate support.

Although the substrate support assembly is described below as utilized in an etch processing chamber, the substrate support assembly may be utilized in other types of plasma processing chambers, such as physical vapor deposition chambers, chemical vapor deposition chambers, ion implantation chambers, among others, and other systems where processing a substrate maintained at the low processing temperature is desirable. It is to be noted however, that the substrate support assemblies and chamber components described herein may be utilized to advantage at other processing temperatures.

Other embodiments described herein include interlocks and cryopump low temperature stages suitable for operating a cryopump system, as further detailed below. The purpose of cryopump system is to generate vacuum by condensing/freezing the gases on to the surfaces present within cryopump, the low temperatures needed to condense/freeze the gas is partly achieved by utilizing magnetocaloric refrigeration.

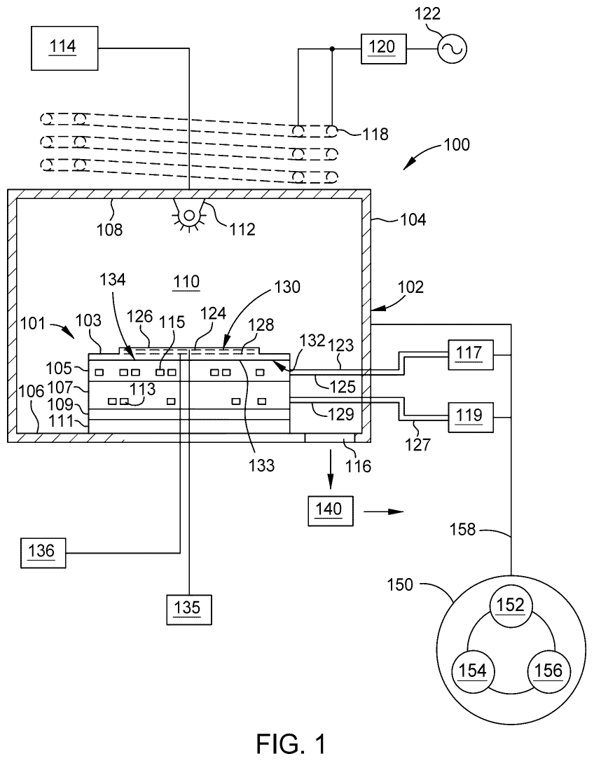

FIG. 1 is a cross-sectional schematic view of an exemplary processing chamber 100, shown configured as an etch chamber, having a substrate support assembly 101. As mentioned above, the substrate support assembly 101 may be utilized in other types of plasma processing chambers, for example plasma treatment chambers, annealing chambers, physical vapor deposition chambers, chemical vapor deposition chambers, and ion implantation chambers, among others, as well as other systems where the ability to uniformly maintain a surface of a workpiece, such as a substrate 124, at a low processing temperature is desirable. Dry reactive ion etching the substrate 124 maintained at a low processing temperature enables ions to bombard the upward facing surfaces of materials disposed on the substrate 124 with decreased spontaneous etching so that trenches with smooth, vertical sidewalls are formed. For example, diffusion of ions in porosities of a low-k dielectric material disposed on the substrate 124 uniformly maintained at the cryogenic processing temperature is decreased while ions continue to bombard the upward facing surface of the low-k dielectric material to form trenches with smooth, vertical sidewalls. Additionally, selectivity of etching one material versus another can be improved at the cryogenic processing temperature. For example, selectivity between silicon (Si) and silicon dioxide (SiO₂) increases exponentially as temperature is decreased.

The processing chamber 100 includes a chamber body 102 having sidewalls 104, a bottom 106 and a lid 108 that enclose a processing region 110. An injection apparatus 112 is coupled to the sidewalls 104 and/or lid 108 of the chamber body 102. A gas panel 114 is coupled to the injection apparatus 112 to allow process gases to be provided into the processing region 110. The injection apparatus 112 may be one or more nozzle or inlet ports, or alternatively a showerhead. Process gases, along with any processing by-products, are removed from the processing region 110 through an exhaust port 116 formed in the sidewalls 104 or bottom 106 of the chamber body 102. The exhaust port 116 is coupled to a pumping system 140, which includes throttle valves and pumps utilized to control the vacuum levels within the processing region 110. Processing by-products are also removed through the exhaust port 116 using the pumping system 140.

The process gases may be energized to form a plasma within the processing region 110. The process gases may be energized by capacitively or inductively coupling RF power to the process gases. In one embodiment, which can be combined with other embodiments described herein, depicted in FIG. 1, a plurality of coils 118 are disposed above the lid 108 of the processing chamber 100 and coupled through a matching circuit 120 to an RF power source 122.

The substrate support assembly 101 is disposed in the processing region 110 below the injection apparatus 112. The substrate support assembly 101 includes an electrostatic chuck (ESC) 103 and an ESC base assembly 105. The ESC base assembly 105 is coupled to the ESC 103 and a facility plate 107. The facility plate 107, supported by a ground plate 111, is configured to facilitate electrical, cooling, heating, and gas connections with the substrate support assembly 101. The ground plate 111 is supported by the bottom 106 of the processing chamber. A dielectric plate 109 electrically insulates the facility plate 107 from the ground plate 111.

The ESC base assembly 105 includes a base channel 115 fluidly coupled to a magnetocaloric chiller 117. The magnetocaloric chiller 117 provides a base fluid, such as a heat transfer fluid, to the base channel 115 so that the ESC base assembly 105, and consequently, the substrate 124, may be maintained at a predetermined low temperature. In one example, the base fluid from the magnetocaloric chiller 117 maintains the ESC base assembly 105 at a temperature lower than a temperature of the facility plate 107.

The facility plate 107 may optionally include a facility channel 113 fluidly coupled to a heating fluid source 119. The heating fluid source 119 provides facility fluid to the facility channel 113 so that the facility plate 107 is maintained a predetermined temperature. The heating fluid source 119 contains a heat transfer fluid that maintains the facility plate 107 at a temperature at or near ambient temperatures.

The heating fluid source 119 is in fluid communication with the facility channel 113 via a facility inlet conduit 127 connected to an inlet (not shown) of the facility channel 113 and via a facility outlet conduit 129 connected to an outlet (not shown) of the facility channel 113 such that the facility plate 107 is maintained at a predetermined ambient temperature. The heating fluid source 119 provides the heat transfer fluid, which is circulated through the facility channel 113 of the facility plate 107. For certain applications, the heat transfer fluid may be a dielectric or electrically insulative so that an electrical path is not formed through the heat transfer fluid when circulated through the substrate support assembly 101. A non-limiting example of a suitable facility fluid includes fluorinated heat transfer fluids such as perfluoropolyether (PFPE) fluids. The heat transfer fluid flowing through the facility channel 113 enables the facility plate 107 to be maintained at the predetermined ambient temperature, which assists in maintaining the dielectric plate 109 at the predetermined ambient temperature.

The ESC 103 has a support surface 130 and a bottom surface 132 opposite the support surface 130. In one embodiment, which can be combined with other embodiments described herein, the ESC 103 is fabricated from a ceramic material, such as alumina (Al₂O₃), aluminum nitride (AIN) or other suitable material. Alternatively, the ESC 103 may be fabricated from a polymer, such as polyimide, polyetheretherketone, polyaryletherketone and the like.

A bond layer 133 is provided at an interface between the bottom surface 132 of the ESC 103 and a top surface 134 of the ESC base assembly 105. The ESC 103 may be made of alumina (Al₂O₃) or aluminum nitride (AIN). The ESC base assembly 105 may be made of aluminum (Al), molybdenum (Mo), a ceramic, or combinations thereof. The bond layer 133 allows strain to be absorbed due to small differences in the CTE of the ESC 103 and ESC base assembly 105 from temperatures of about 90 degrees Celsius to about −200 degrees Celsius during operation.

The ESC 103 includes a chucking electrode 126 disposed therein. The chucking electrode 126 may be configured as a mono polar or bipolar electrode, or other suitable arrangement. The chucking electrode 126 is coupled through an RF filter and the facility plate 107 to a chucking power source 135, which provides a DC power to electrostatically secure the substrate 124 to the support surface 130 of the ESC 103. The RF filter prevents RF power utilized to form a plasma (not shown) within the processing chamber 100 from damaging electrical equipment or presenting an electrical hazard outside the chamber.

The ESC 103 includes one or more resistive heaters 128 embedded therein. The resistive heaters 128 are utilized to control the temperature of the ESC 103, which is cooled by the ESC base assembly 105, such that low processing temperatures suitable for processing a substrate 124 disposed on the support surface 130 of the substrate support assembly 101 may be maintained. The resistive heaters 128 are coupled through the facility plate 107 and an RF filter to a heater power source 136. The RF filter prevents RF power utilized to form a plasma (not shown) within the processing chamber 100 from damaging electrical equipment or presenting an electrical hazard outside the chamber. The heater power source 136 may provide 500 watts or more power to the resistive heaters 128. The heater power source 136 includes a controller (not shown) utilized to control the operation of the heater power source 136, which is generally set to heat the substrate 124 to a predetermined low temperature. In one embodiment, which can be combined with other embodiments described herein, the resistive heaters 128 include a plurality of laterally separated heating zones, wherein the controller enables at least one zone of the resistive heaters 128 to be preferentially heated relative to the resistive heaters 128 located in one or more of the other zones. For example, the resistive heaters 128 may be arranged concentrically in a plurality of separated heating zones. The resistive heaters 128 maintain the substrate 124 at a low processing temperature suitable for processing. In one embodiment, which can be combined with other embodiments described herein, the low processing temperature may be equal to or less than about 20 degrees Celsius.

The magnetocaloric chiller 117 is in fluid communication with the base channel 115 via a base inlet conduit 123 and via a base outlet conduit 125 such that the ESC base assembly 105 is maintained at a predetermined temperature. In one embodiment, which can be combined with other embodiments described herein, the magnetocaloric chiller 117 contains a base fluid. The base fluid comprises a composition that remains a liquid at low temperatures during operating pressures. A non-limiting example of suitable base fluid includes fluorinated heat transfer fluids. The magnetocaloric chiller 117 provides the base fluid, which is circulated through the base channel 115 of the ESC base assembly 105. The base fluid flowing through the base channel 115 enables the ESC base assembly 105 to be maintained at the low temperature, which assists in controlling the lateral temperature profile of the ESC 103 so that the substrate 124 disposed on the ESC 103 is uniformly maintained at the low processing temperature. In one embodiment, which can be combined in other embodiments described herein, the magnetocaloric chiller 117 is a single-stage chiller operable to maintain the low temperatures less than about 20 degrees Celsius or even as low as −60 degrees Celsius.

The magnetocaloric chiller 117 utilizes magnetocaloric refrigeration. Magnetic refrigeration is a cooling technology based on the magnetocaloric effect. This technique can be used to attain extremely low temperatures. Magnetocaloric refrigeration offers following advantages compared to current conventional refrigeration technology. Magnetocaloric refrigeration eliminates refrigerant in the working fluid, reduces energy consumption by as much or more than 50% and operates at low pressure that leads to high reliability. The magnetocaloric chiller 117 utilizing magnetocaloric refrigeration is provided with additional controls/monitoring for working fluid pressure, working fluid particle filtering, and other controls for maintaining the properties of the working fluid.

The magnetocaloric chiller 117 may also be coupled to a controller 150 that enables interlock functionality. The controller 150 includes a processor 152, a memory 154, and support circuits 156 that are coupled to one another. The controller 150 is electrically coupled to the processing chamber 100 and the magnetocaloric chiller 117 via a wire 158.

The processor 152 may be one of any form of general purpose microprocessor, or a general purpose central processing unit (CPU), each of which can be used in an industrial setting, such as a programmable logic controller (PLC), supervisory control and data acquisition (SCADA) systems, or other suitable industrial controller. The memory 154 is non-transitory and may be one or more of readily available memory such as random access memory (RAM), read only memory (ROM), or any other form of digital storage, local or remote. The memory 154 contains instructions, that when executed by the processor 152, facilitates execution of a method for cooling an electrostatic chuck. The instructions in the memory 154 are in the form of a program product such as a program that implements the method of the present disclosure. The program code of the program product may conform to any one of a number of different programming languages. Illustrative computer-readable storage media include, but are not limited to: (i) non-writable storage media (e.g., read-only memory devices within a computer such as CD-ROM disks readable by a CD-ROM drive, flash memory, ROM chips, or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the methods described herein, are examples of the present disclosure.

A computer program coupled to the controller 150 performs operations on the processing system for operating the ESC and performing processing on substrates based on a recipe.

Sensors interfaced with the magnetocaloric chiller 117 provide pressure, flow, temperature, fluid resistivity, valve condition, motor diagnostics and/or other metrics of the magnetocaloric chiller 117 and/or processing chamber 100 to provide an electronic warning and/or to automatically shut down or modified the operation of the processing system and/or magnetocaloric chiller 117 based on the sensed metrics.

The computer program coupled to the controller 150 performs operations on the magnetocaloric chiller 117 to monitor the sensors. The controller 150 may compare the temperature of the working fluid to a set point temperature. The controller 150 may signal magnetocaloric refrigeration to remove heat from the working fluid in returning to the processing chamber 100. The controller 150 may monitor one or more working fluid resistivity, pressure and temperature for fault conditions. The controller 150 may signal an interlock or go condition.

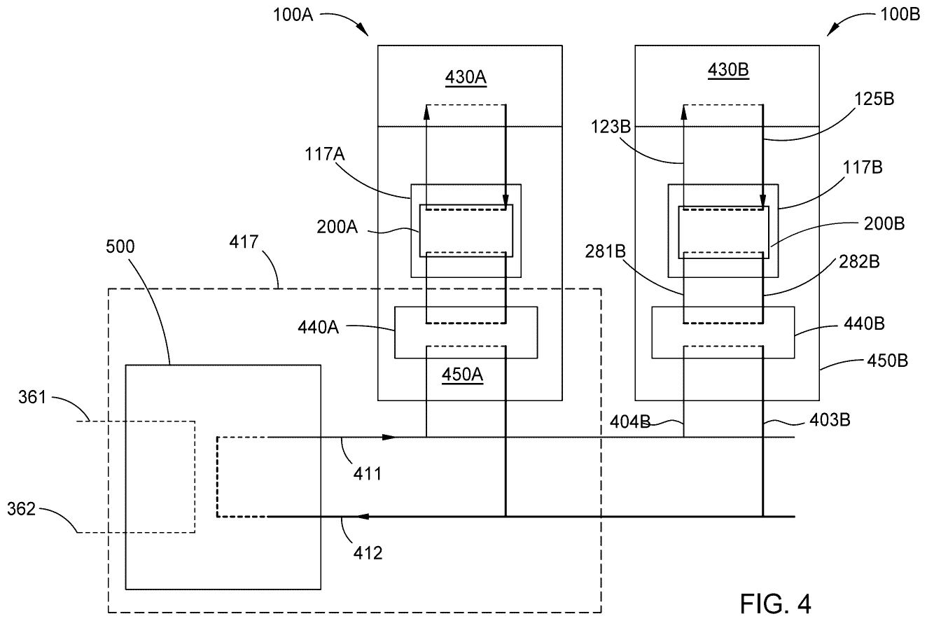

In yet another example, a cryopump system 417 (as shown in FIG. 4) may also be used to generate a vacuum pressure in an exhaust of a vacuum chamber, such a semiconductor or other integrated circuit device processing chamber. Components of the cryopump system 417 may be connected across multiple vacuum chambers. The cryopump system 417 includes a magnetocaloric refrigeration MCR unit. One example of a cryopump system 417 is illustrated in FIG. 4 below.

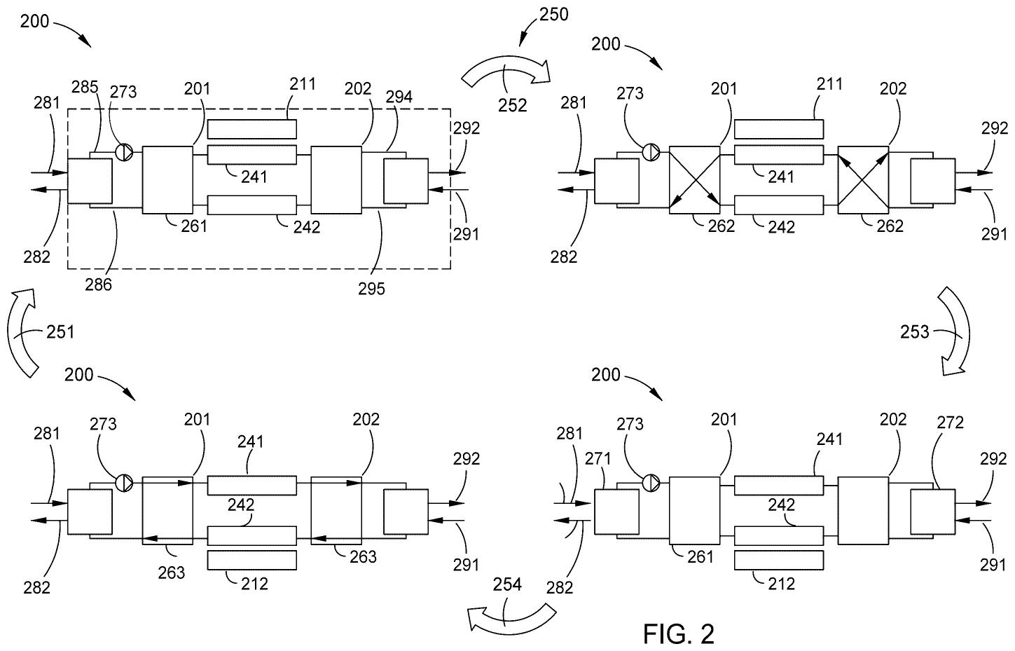

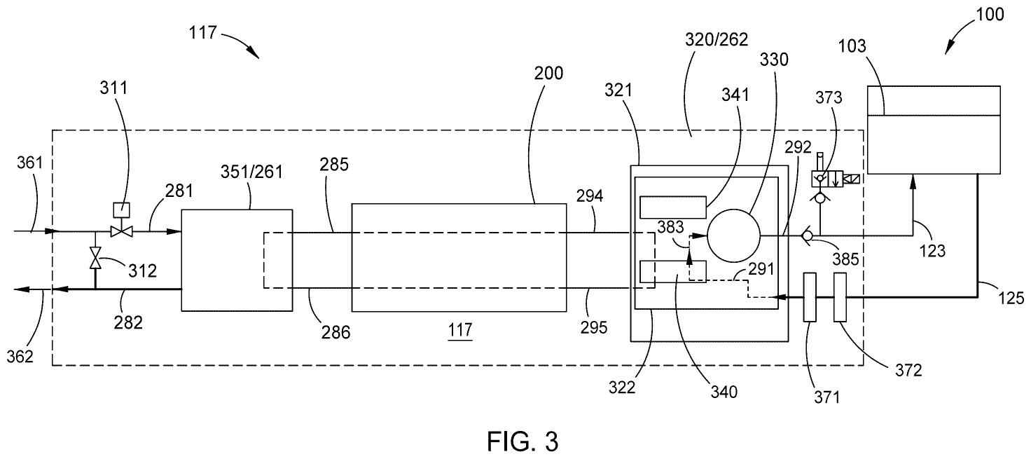

The magnetocaloric chiller 117 utilizes illustrating magnetocaloric refrigeration. FIG. 2 is provided to better understand how magnetocaloric refrigeration operates. FIG. 2 is a representative figure illustrating the operation of a magnetocaloric refrigeration (MCR) unit 200. The MCR unit 200 has a process cooling water (PCW) inlet 281 and a PCW outlet 282. The MCR unit 200 additionally has a heat transfer fluid (HTF) inlet 291 and a HTF outlet 292. The PCW inlet 281 and PCW outlet 282 are coupled to a hot heat exchanger 271. The hot heat exchanger 271 additionally has a hot heat exchanger outlet 285 and a hot heat exchanger inlet 286. The HTF inlet 291 and HTF outlet 292 are coupled to a cold heat exchanger 272. The cold heat exchanger 272 additionally has a cold heat exchanger outlet 295 and a cold heat exchanger inlet 294. It should be noted that the examples provided with respect to FIGS. 3 and 4 show the cold heat exchanger 272 and the hot heat exchanger 271 outside the MCR unit 200. However, the cold heat exchanger 272 and the hot heat exchanger 271 may be included with the MCR unit 200 and the description of the MCR unit 200 benefits the inclusion of the cold heat exchanger 272 and the hot heat exchanger 271. In one example, the PCW is provided by the facility at a temperature of around 20° Celsius.

The hot heat exchanger outlet 285 couples to the cold heat exchanger inlet 294. The hot heat exchanger inlet 286 is fluidly coupled to the cold heat exchanger outlet 295. Magnetocaloric material (MCM) is a solid material provided to adjust the temperature of a fluid internal to the MCR unit 200. The internal fluid is transported between the hot heat exchanger 271 and cold heat exchanger 272 disposed in the MCR unit 200. The HTF inlet 291 receives heat transfer fluid (HTF) used in cooling the processing chamber 100. The MCR unit 200 removes heat from the HTF to provide an appropriate cooling fluid temperature back to the ESC 103. The HTF outlet 292 returns the cooled HTF, now cooling fluid, back to the ESC 103 in the processing chamber 100. It should be understood that the loop of the HTF, the internal fluid of the MCR unit 200 and the PCW are all closed loops and the HTF, the internal fluid and the PCW do not mix.

A pump 273 may circulate the flow of the internal fluid through the MCR unit 200. The MCR unit 200 additionally has one or more valves 201/202 to direct the internal fluid between the magnetocaloric material (MCM) units 241 and 242. In the example provided, the MCR unit 200 has a first MCM unit 241 and a second MCM unit 242. It should be appreciated however, that the MCR unit 200 may have multiple MCM units.

Additionally, the MCR unit 200 has a first valve 201 and a second valve 202. The valves 201/202 may operate to move the flow of the internal fluid between the MCM units 241/242 and the heat exchangers 271/272. The valves 201/202 may operate in a first position wherein a flow path for the internal fluid of the MCR unit 200 across the valves 201/202 is maintained. The valves 201/202 may operate in a second position wherein the flow path for the internal fluid across the valves 201/202 is crossed. For example, the flow of the internal fluid from the hot heat exchanger outlet 285 of the hot heat exchanger 271 through the valve 201 placed in the first position goes to the first MCM unit 241. In a second example, the flow of the internal fluid from the hot heat exchanger outlet 285 of the hot heat exchanger 271 through the valve 201 in the second position goes to the second MCM unit 242. It should be appreciated from the example above, the valve 202 operate similarly as described above with a respective valve 201 and as shown in FIG. 2. The valves 201/202 may additionally operate in a third position wherein the flow path of the internal fluid across the valves 201/202 is closed and the internal fluid does not move through the valve 201/202.

Each MCM unit (241/242) has a respective solid MCM material. The MCM for the MCR unit 200 may include materials such as gadolinium and gadolinium base alloys, La—Fe—Si alloys, and Mn—Fe—Si alloys among other suitable materials. The MCM may be a solid material that undergoes temperature change because of change in a magnetic field.

Each MCM unit (241/242) has a magnet operable between an on state and an off state. In one example, there is one magnet shared between each MCM unit 241/242. In another example, each MCM unit 241/242 has a respective magnet not shared with other MCM units. For ease of discussion, the MCM units 241/242 are discussed with each having a single non-shared magnet.

The first MCM unit 241 has a first magnet 211 operated between the on state and the off state. The second MCM unit 242 has a second magnet 212 operated between the on state and the off state. For example, second magnet 212 may be energized to magnetize the MCM material in the second MCM unit 242 when the magnet 212 is in the on state. Likewise, magnet 212 may be placed in an off state wherein the MCM material is not subject to a magnetic field in the second MCM unit 242. Although two magnets, i.e., first magnet 211 and second magnet 212, are described in the operation of the MCR unit 200, it should be appreciated that a single magnet may be moved to provide the same effect. For example, a magnet may be moved to the location shown by the first magnet 211 and later moved to the location of the second magnet 212 for providing the magnetic field in the second MCM unit 242.

The MCR unit 200 operates through a cycle 250 to create a continuous cooling effect. The cycle 250 moves through four operations to complete the continuous cooling effect. In a first operation 251, the first valve 201 and the second valve 202 are positioned in a no flow state, i.e., a third position, wherein the internal fluid does not flow through the valves, MCM units 241/242, or the heat exchangers 271/272. The magnet 211 is in an on state for providing magnetization of the MCM in the first MCM unit 241. The MCM in the first MCM unit 241 undergoes adiabatic magnetization wherein the temperature of the MCM causes the temperature of the internal fluid to rise. The magnet 212 is provided in an off state. The MCM in the second MCM unit 242 undergoes adiabatic demagnetization that causes the temperature of the internal fluid to fall.

In a second operation 252, the internal fluid flow is provided between the hot heat exchanger, 271, the cold heat exchanger 272, and the MCM units 241/242. The first valve 201 and the second valve 202 are both placed in the second positioned. The magnet 211 is maintained in the on state to maintain the magnetization of the MCM, a solid material, in the MCM unit 241. The fluid Internal to the MCM unit is moved in one direction from the hot heat exchanger outlet 285 of the hot heat exchanger 271, through the first valve 201, the second MCM unit 242, and the second valve 202 to the cold heat exchanger inlet 294 of the cold heat exchanger 272. The Internal fluid is moved in the return direction from the cold heat exchanger outlet 295 of the cold heat exchanger 272 through the second valve 202, the first MCM unit 241, and the first valve 201 and back to the hot heat exchanger inlet 286 of the hot heat exchanger 271. The first MCM unit 241 is now hot. The hot temperature of the first MCM unit 241 is reduced by the internal fluid, thereby increasing the temperature of the internal fluid. The second MCM unit 242 is cold. The cold temperature of the second MCM unit 242 is increased by the internal fluid, thereby decreasing the temperature of the internal fluid.

In a third operation 253, the first valve 201 and the second valve 202 are positioned in the no flow state, i.e., a third position, wherein the internal fluid does not flow through the first valve 201, the second valve 202, MCM units 241/242, or the heat exchangers 271/272. The magnet 211 is provided in and off state. The MCM in the first MCM unit 241 undergoes adiabatic demagnetization wherein the temperature of the MCM in the MCM unit 241 then falls. The magnet 212 for the second MCM unit 242 is placed in the on state for providing a magnetic field to the MCM in the second MCM unit 242. The MCM in the second MCM unit 242 undergoes adiabatic magnetization causing the temperature of the MCM to rise.

In a fourth operation 254 flow is again provided between the hot and cold heat exchangers 271/272 and the MCM units 241/242. The first valve 201 and the second valve 202 are both placed in the first positioned. The magnet 212 is maintained in the on state to maintain the magnetic field on the MCM material in the second MCM unit 242. The fluid internal to the MCR unit 200 is moved in one direction from the hot heat exchanger outlet 285 of the hot heat exchanger 271, through the first valve 201, the first MCM unit 241, and the second valve 202 to the cold heat exchanger inlet 294 of the cold heat exchanger 272. The fluid internal to the MCR unit 200 is moved in the return direction from the cold heat exchanger outlet 295 of the cold heat exchanger 272 through the second MCM unit 242 and back to the hot heat exchanger inlet 286 hot heat exchanger 271. The second MCM unit 242 adds heat to the internal fluid. The internal fluid temperature drops as it moves through the MCM of the first MCM unit 241.

After the fourth operation 254, the cycle 250 then moves back to operation 251 such that the MCR unit 200 provides a continuous cooling effect for the internal fluid at the cold heat exchanger 272.

FIG. 3 is a cross-sectional schematic view of the magnetocaloric chiller 117 which include the MCR unit 200 for cooling the electrostatic chucks (ESC) 103. The processing chamber 100 has an ESC 103 that is coupled with the cooling loop to the magnetocaloric chiller 117. The magnetocaloric chiller 117 is coupled by the base inlet conduit 123 and the base outlet conduit 125 to the ESC 103. The heat transfer fluid (HTF) from the cooling loop inside the ESC 103 enters the magnetocaloric chiller 117 through the base outlet conduit 125. After the heat transfer fluid (HTF) is cooled in the magnetocaloric chiller 117, the heat transfer fluid is supplied back via the base inlet conduit 123 to the ESC 103. In this manner, the HTF can be relied on for maintaining the temperature of the ESC 103. The magnetocaloric chiller 117 additionally has a process cooling water (PCW) supply 361 and a PCW return 362. Facility process cooling water enters the magnetocaloric chiller 117 through the PCW supply 361. The process cooling water removes heat from the magnetocaloric chiller 117 and exits the chiller via the PCW return 362.

The chiller has a cold heat exchanger 320, a MCR unit 200, and a hot heat exchanger 351. The cold heat exchanger 320 operates in the same manner and in place of cold heat exchanger 272 shown in FIG. 2. The hot heat exchanger operates in the same manner and in place of the hot heat exchanger 271 shown in FIG. 2. The base inlet conduit 123 and the base outlet conduit 125 are coupled to the cold heat exchanger 320. The hot heat exchanger 351 is coupled to the process cooling water (PWC) outlet 282 and the PWC inlet 281. Both the cold heat exchanger 320 and the hot heat exchanger 351 have an internal fluid circulation through the MCR unit 200 within the magnetocaloric chiller 117.

The magnetocaloric chiller 117 may have a particle filter 371 and a resistivity control unit 372 disposed on the base outlet conduit 125 for working fluid entering the magnetocaloric chiller 117. The magnetocaloric chiller 117 may additionally have a purge valve 373 as well as a non-return valve 385, or backflow prevent, disposed on the base inlet conduit 123 returning cooled working fluid back to the ESC 103. For high dielectric working fluids, the dielectric working fluid may have a mechanism for dissipating the static charge generated by the flow of the working fluid through the magnetocaloric chiller 117. An optional ground, or possibly the resistivity control unit 372, may be relied on for dissipating the static charge based on type of fluid. The resistivity control unit 372 maintains electrical resistivity of the working fluid within specified limits. The particle filter 371 removes particle contaminants if any from the working fluid. The non-return valve 385 ensures the HTF does not flow back to the main tank through the base inlet conduit 123. The purge valve 373 may be used during maintenance of the ESC 103 to move the HTF out the ESC 103 and into the magnetocaloric chiller 117. High-pressure clean dry air (CDA) or N2 or dry air from purge valve 373 flows towards ESC 103 instead of towards c. The heat transfer fluid from the cooling loop inside the ESC 103 enters the magnetocaloric chiller 117 through the heat transfer fluid return 381. After the heat transfer fluid is cooled in the magnetocaloric chiller 117, the heat transfer fluid is supplied back via HTF supply 386 to the ESC 103. In this manner, the heat transfer fluid can be relied on for maintaining the temperature of the ESC 103.

The cold heat exchanger 320 has a main tank 322. The main tank 322 has a pump 330. The purpose of main tank 322 is to aid in meeting the temperature stability. The main tank 322 may or may not have a heat exchanger 340. The main tank 322 of the cold heat exchanger 320 may additionally, or optionally, have a heater 341. The pump 330 is configured move the HTF from the base outlet conduit 125, through the cold heat exchanger 320, and out the base inlet conduit 123 to the ESC 103. For pressure and/or flow regulation, the pump 330 is connected to a variable frequency drive/inverter drive (VFD). The VFD controls speed and torque of the pump 330 by varying the frequency of the input electricity for regulating the flow of the HTF through the cold heat exchanger 320.

The heater 341 is configured to provide heat to the HTF when the HTF return temperature is lower than set point temperature. In one example, the heater 341 may be a resistive heater that is submerged in the main tank 322. Alternately, the heater 341 may be an inline heater through which the HTF flows.

The cold heat exchanger 320 may have a sub tank or storage tank 321. The main tank 322 provides space for the HTF to meet temperature stability and to collect HTF during maintenance. The main tank 322 has a minimum capacity to accommodate the fluid volume of the HTF inside the magnetocaloric chiller 117. The sub tank 321 has a minimum capacity to accommodate fluid volume of the HTF additionally disposed in the ESC 103, the hoses connecting the ESC 103, and the chiller 117. In one example, the cold heat exchanger inlet 294, cold heat exchanger outlet 295, the base outlet conduit 125 and the base inlet conduit 123 are all directly coupled to the main tank 322. In one example, the storage tank 321 and the main tank 322 are combined and a single tank. In another example, the storage tank 321 and the main tank 322 are separate tanks with each having a separate and distinct volume for storing HTF.

The cold heat exchanger 320 receives the HTF from the base outlet conduit 125, and after removing heat from the HTF, returns the HTF to the ESC 103 via the base inlet conduit 123. The cold heat exchanger inlet 294 receives internal fluid from the MCR unit 200 to cool the HTF. The internal fluid flows through the cold heat exchanger 320 in a closed loop for removing heat from the HTF.

The internal fluid exits the cold heat exchanger 320 via the cold heat exchanger outlet 295 to return the now hotter internal fluid through the MCR unit 200 to the hot heat exchanger 351/271. The operation for cooling the internal fluid by the MCR unit 200 is as described above with respect to FIG. 2.

The hot heat exchanger 351 is coupled through the hot heat exchanger outlet 285 and the hot heat exchanger inlet 286 in the MCR unit 200 to the cold heat exchanger 320. The hot heat exchanger 351 is additionally coupled by the PCW inlet 281 and PCW outlet 282 the PWC water supply. The PCW inlet 281 is coupled to the PCW supply 361. The PCW outlet 282 is coupled to the PCW return 362. A solenoid ON/OFF valve 311 or proportional control valve may couple the PCW supply 361 and the PCW inlet 281. The solenoid ON/OFF valve 311 may operate based on deviations between a HTF set temperature and HTF actual temperature. For example, a controller may monitor the HTF temperature. The controller may determine the HTF is below a set point temperature and cause the solenoid ON/OFF valve 311 to enter an off or no flow state. The solenoid ON/OFF valve 311 in the OFF state prevents PCW from the PCW supply 361 from flowing into the PCW inlet 281. Similarly, the controller may determine the HTF is above a set point temperature and cause the solenoid ON/OFF valve 311 to enter an ON or flow state. The solenoid ON/OFF valve 311 in the ON state allows PCW from the PCW supply 361 to flow into the PCW inlet 281. The solenoid ON/OFF valve 311 is in the ON state when the HTF needs to be cooled. Similarly, the solenoid ON/OFF valve 311 is in the OFF when HTF needs to be heated.

The magnetocaloric chiller 117 additionally includes a PCW bypass valve 312 coupled between the PCW supply 361 and the PCW return 362. When the solenoid ON/OFF valve 311 opens and closes, the change in flow creates a water hammering effect due to pressure fluctuations. To prevent the water hammering on the PCW supply 361, the some of the PCW is made to flow through the PCW bypass valve 312 to absorb the impact from the change in the pressure in the flow of the PCW.

The magnetocaloric chiller 117 may additionally be equipped with an interlock for fault detection and warnings. For example, the controller monitoring the magnetocaloric chiller 117 may detect abnormal operation of subcomponents such as a stuck valve, or pump failure. The controller may monitor MCM motor diagnostics, over temperature/under temperature conditions, and over pressure/under pressure monitoring of the chiller internal cooling fluids. The controller may monitor the cooling fluids for resistivity, contamination or other indicators of potential failure.

In operation, the magnetocaloric chiller 117 may be located above or below the processing chamber 100 in the fab sub floor, at the same level of the processing chamber 100, or on a floor different from the processing chamber 100. The magnetocaloric chiller 117 may advantageously reduce energy consumption between 30% and about 55% as compared to a conventional chiller.

FIG. 4 is a cross-sectional schematic view of a cryopump system 417 utilizing magnetocaloric refrigeration for generating desired vacuum levels. FIG. 4 illustrates an example for multiple vacuum chambers 100A/B. The vacuum chamber 100A includes a cryopump 450A connected to the exhaust of vacuum chamber 100A. The vacuum chamber 100B includes cryopump 450B connected to the exhaust of vacuum chamber 100B. The cryopumps 450A/B are fluidly coupled to a compressor unit 500. The cryopumps 450A/B and the compressor unit 500 form the cryopump system 417. Components of the cryopump system 417 depicted in FIG. 4 are merely provided to show the orientation for how the components are arranged in the cryopump system 417 to generate desired vacuum levels in the vacuum chambers 100A/B.

The discussion that follows will be with respect to vacuum chamber 100B. However, it should be appreciated that the one or more vacuum chambers 100A/B may be arranged as shown and the operation for generating a vacuum in each vacuum chamber 100A/100B may be substantially the same. The cryopump system 417 are part of cryopump system that generates the intermediate temperature and are based on cryocooler technologies such as Gifford-McMahon cycle.

The vacuum chamber 100B is coupled to cryopump 450B. The cryopump 450B is part of the cryopump system 417 a having low temperature stage 200A/B. The vacuum chamber 100B is coupled via base inlet conduit 123 and base outlet conduit 125 to the low temperature stage 200B in the cryopump 450B to generate a desired vacuum level in the vacuum chamber 100B. The cryopump 450B has one or more cryopanels. The cryopanels are surfaces present in the cryopump 450B on which gases condense/freeze which thereby generate a desired vacuum level.

The low temperature stage 200B is coupled to the cryopump system 417. The cryopump system 417 maintains the temperature of cryopanels at desired temperature. The low temperature cooling stage 200B operates similarly to MCR unit 200 shown and described in FIG. 2. The low temperature stage 200B cools the low temperature cryopanel in the cryopump 450B based on magnetocaloric refrigeration.

The cryopump system 417 additionally has a high temperature stage 440A/B. The high temperature stage 440B cools the high temperature cryopanel in the cryopump 450B based on cryocoolers utilizing Gifford-McMahon or other cooling cycles. The high temperature stage 440B provides the intermediate temperature that is needed by the MCR unit (low temperature cooling stage 200B) to reach low temperatures.

The high temperature stage 440B and low temperature stage 200B are coupled either by the working fluid, helium, or by a thermal switch. The high temperature stage 440B precools the helium entering into the low temperature stage 200B. The precooling stage provided by the high temperature stage 440B provides an intermediate temperature for the low temperature stage 200B. The precooling stage also maintains the high temperature cryopanels temperature at a desired level. The intermediate temperature enables the low temperature stage 200B to generate the low temperature and pressure needed for the vacuum chamber 100B. That is, the high temperature stage 440B enables the low temperature stage 200B to generate the low temperature needed for the cryopump 450B. The heat exchange between low temperature stage 200B and the high temperature stage 440B could be either with the working fluid, i.e., the same fluid supplied by the compressor 500, or with the use of a thermal switch.

The cryopump 450B, i.e., Low temperature stage 200B and high temperature stage 440B, generates pressures in the level of between about 10⁻³ Torr to about 10⁻¹² Torr, such as about 10⁻⁸ Torr, by condensing/freezing the gases. The cryopump 450B may have cryogenic refrigeration with two stages, i.e., a low temperature stage and a high temperature stage. The low temperature stage being between about 8 K to bout 20 K and the high temperature stage being between about 20 K to about 100 K.

The cryopump 450B is fluidly coupled by a return line 403B to a gas return line 412. The gas return line 412 is a common shared foreline for each cryopump 450A and 450B, associated with vacuum chambers 100A and 100B. The gas return line 412 returns working fluid, such as helium, to the compressor 500. The compressor unit 500 supplied the working gas, i.e., helium, to the high temperature stage 440A/B via supply gas line 411.

The compressor unit 500 receives gas via the gas return line 412. The compressor unit 500 may be liquid cooled or air cooled and be inverter driven for control flow, pressure control, as well as for energy efficiency. The compressor unit 500 is configured to supply compressed helium gas to the cryopumps 440A/440B. Advantageously, a plurality of vacuum processing systems can be efficiently and cost effectively maintained at a vacuum pressure.

While the foregoing is directed to examples of the present disclosure, other and further examples of the disclosure may be devised without departing from the basic scope thereof, and the scope thereof is determined by the claims that follow.

What is claimed is:

1. A processing system comprising:
a body having a bottom, a lid and sidewalls, wherein the bottom, lid and sidewalls enclose a processing volume;
a substrate support assembly disposed in the processing volume, the substrate support assembly comprising:
an electrostatic chuck (ESC);
a cooling base coupled to the electrostatic chuck;
a facility plate coupled to the cooling base; and
one or more electrical connectors positioned in the substrate support assembly, the electrical connectors in electrical communication with the electrostatic chuck; and
a magnetocaloric chiller fluidly coupled to one or more cooling channels in the electrostatic chuck.

2. The processing system of claim 1, wherein the magnetocaloric chiller further comprises:
a cold heat exchanger fluidly coupled to a base inlet and a base outlet of the processing system, the base inlet and outlet in fluid communication with the one or more cooling channels with a heat transfer fluid;
a magnetocaloric refrigeration unit coupled to the cold heat exchanger with a fluid internal to the magnetocaloric refrigeration unit; and
a hot heat exchanger fluidly coupled to magnetocaloric refrigeration unit with the fluid internal to the magnetocaloric refrigeration unit, the hot heat exchanger additionally fluidly coupled to a facility process cooling water.

3. The processing system of claim 2, wherein the fluid internal to the magnetocaloric refrigeration unit, the facility process cooling water and the heat transfer fluid do not mix.

4. The processing system of claim 2, wherein the magnetocaloric refrigeration unit further comprises:
a first magnetocaloric material unit comprising:
a first magnet capable of being placed in a magnetized state and a demagnetized state; and
a first magnetocaloric material suitable of being magnetized and demagnetized by the magnet.

5. The processing system of claim 4, wherein the first magnetocaloric material is selected from one of gadolinium and gadolinium base alloys, La—Fe—Si alloys, and Mn—Fe—Si alloys.

6. The processing system of claim 4, wherein when first magnet is in the magnetized state, the first magnetocaloric material undergoes adiabatic magnetization causing a temperature of the internal fluid to rise.

7. The processing system of claim 4, wherein the magnetocaloric refrigeration unit further comprises:
a second magnetocaloric material unit comprising:
a second magnetocaloric material suitable of being magnetized and demagnetized.

8. The processing system of claim 7, wherein the second magnetocaloric material unit includes the first magnet moveable between the first magnetocaloric material unit and the second magnetocaloric material unit, wherein the second magnetocaloric material is capable of being magnetized and demagnetized by the first magnet.

9. The processing system of claim 7, wherein the second magnetocaloric material unit includes a second magnet capable of being placed in a magnetized state and a demagnetized state, wherein the second magnetocaloric material is capable of being magnetized and demagnetized by the second magnet.

10. A processing system comprising:
a first vacuum chamber;
a first cryopump system coupled to the first vacuum chamber; and
a first low temperature cooling stage of the first cryopump system utilizing magnetocaloric refrigeration operable to maintain low temperature of cold cryopanels for achieving a desired vacuum level in the first vacuum chamber.

11. The processing system of claim 10, wherein the first cryopump system further comprises:
a cryopump having cold cryopanels coupled to the first vacuum chamber, wherein the first low temperature cooling stage is fluidly coupled to the first cryopump with a fluid internal to the first low temperature cooling stage, the first low temperature cooling stage further comprising:
a first magnetocaloric material unit comprising:
a first magnet capable of being placed in a magnetized state and a demagnetized state; and
a first magnetocaloric material suitable of being magnetized and demagnetized by the magnet.

12. The processing system of claim 11, wherein the cryopanels condense and/or freeze gases which thereby generate a desired vacuum level in the first vacuum chamber.

13. The processing system of claim 12, wherein the first cryopump system further comprises:
a first high temperature cooling stage in fluid communication with the low temperature cooling stage; and
a foreline in fluid communication with the high temperature cooling stage and a compressor.

14. The processing system of claim 13, wherein helium is the fluid in the foreline communicating between the high temperature cooling stage and the compressor.

15. The processing system of claim 13 further comprising:
a second vacuum chamber;
a second cryopump system coupled to the second vacuum chamber; and
a second low temperature cooling stage of the second cryopump system utilizing magnetocaloric refrigeration operable to maintain low temperature of cold cryopanels for achieving a desired vacuum level in the second vacuum chamber, wherein the second cryopump system is fluidly coupled to the foreline.

16. A magnetocaloric chiller for an electrostatic chuck, the magnetocaloric chiller comprising:
a cold heat exchanger in fluid communication with heat transfer fluid in one or more cooling channels of an electrostatic chuck;
a first magnetocaloric refrigeration unit having a first magnet and a first magnetocaloric material in communication with an internal fluid flowing to the cold heat exchanger, the first magnet capable of being in a magnetized and demagnetized state; and
a hot heat exchanger having the internal fluid in communication with the magnetocaloric refrigeration unit and process cooling water in fluid communication with a process cooling water source, wherein the heat transfer fluid, the internal fluid of the first magnetocaloric refrigeration unit and the process cooling water do not mix.

17. The magnetocaloric chiller of claim 16 further comprising:
a second magnetocaloric refrigeration unit having a second magnetocaloric material in communication with the internal fluid flowing to the cold heat exchanger and the hot heat exchanger.

18. The magnetocaloric chiller of claim 17, wherein when first magnet is in the magnetized state, the first magnetocaloric material undergoes adiabatic magnetization causing a temperature of the internal fluid to rise.

19. The magnetocaloric chiller of claim 18, further comprising:
a second magnetocaloric material unit having a second magnetocaloric material suitable of being magnetized and demagnetized.

20. The magnetocaloric chiller of claim 19, wherein the second magnetocaloric material unit includes the first magnet moveable between the first magnetocaloric material unit and the second magnetocaloric material unit, and wherein when first magnet is in the magnetized state and located at the second magnetocaloric material unit, the second magnetocaloric material undergoes adiabatic magnetization causing the temperature of the internal fluid to rise.
